(19) United States
(12) Patent Application Publication
(10) Pub. No.: US 2008/0177643 A1
(43) Pub. Date: Jul. 24, 2008

(54) System and method for invoice management

(76) Inventors: Clifton W. Matthews, Plano, TX (US); Jeffrey R. Anderson, Dallas, TX (US); Douglas W. Brennecke, Allen, TX (US); Dale R. Stewart, Southlake, TX (US); Khurshid A. Shaikh, Scottsdale, AZ (US)

Correspondence Address: JACKSON WALKER LLP, 901 MAIN STREET, SUITE 6000, DALLAS, TX, 75202-3797, US

(21) Appl. No.: 11/656,183

(22) Filed: Jan. 22, 2007

(51) Int. Cl. G06Q 10/00

(52) U.S. Cl. 705/30

(57) ABSTRACT

A managed invoice management system is provided that eliminates paper and manual functions from the accounts payable process. The system allows a user to digitize invoices, extract key data, add general ledger codes, and validate invoices against purchase orders for each of a plurality of clients, based on a client profile containing predetermined allowable data fields. The system electronically routes invoices from input to one or more approval personnel, wherein the approval personnel are user-selectable from the client profile, and provides real-time invoice tracking and expense analysis.

### FIELD OF THE INVENTION

The present invention is generally related to invoice management systems, and more specifically to end-to-end accounts payable invoice management systems.

### BACKGROUND OF THE INVENTION

High cost of manual invoice processing. For most companies with annual invoicing volume below 500,000 invoices, accounts payable remains a paper-intensive, highly manual business process. Third-party research studies estimate the true cost of manually processing a single invoice to be anywhere from $9 to $35. Primary cost components include labor, equipment, software, postage & supplies, late payment fees, and missed early payment discounts. Further, the typical costs to implement and maintain an automated invoice processing system are steep enough to make such an investment unviable for most companies with annual invoicing volume below 500,000 invoices.

Lack of expense control and accountability. Paper-intensive accounts payable processes do not enable 100% accountability of expenses nor do they allow companies to track and manage expenses on a real-time basis. Further, these manual processes often carry high error rates in terms of both data accuracy and invoice payment accuracy. This is due to any of a number of manual process steps including inefficient invoice data entry, inconsistent application of business rules for payment approvals, manual routing of paper invoices, and the absence of an electronic system to share and track invoices across all levels of an organization. Finally, a manual accounts payable process does not provide companies with the audit trail required to comply with government accounting guidelines such as Sarbanes-Oxley.

### SUMMARY OF INVENTION

In one exemplary, embodiment, the present invention achieves technical advantages as a managed invoice management solution that eliminates all paper and manual functions from the accounts payable process. One embodiment of the invention digitizes invoices, extracts key data, adds general ledger (G/L) codes, validates invoices against purchase orders (POs) as necessary, electronically routes invoices from input to approval with existing G/L systems, and provides real-time invoice tracking and expense analysis. Through automation and analytics, businesses can significantly reduce costs, gain greater control of expenses, and ensure compliance with regulatory guidelines. Clients can avoid the expense of purchasing and maintaining software while acquiring the robust capabilities of an Internet-based system.

### BRIEF DESCRIPTION OF THE DRAWINGS

FIG. 1 is a diagram of a method for invoice entry and approval in accordance with an exemplary embodiment of the present invention;

FIG. 2 is a diagram of a daily method for a scan center in accordance with an exemplary embodiment of the present invention;

FIG. 3 is a diagram of a method for client system setup in accordance with an exemplary embodiment of the present invention;

FIG. 4 is a diagram of a method for mail sorting and processing in accordance with an exemplary embodiment of the present invention;

FIG. 5 is a diagram of a method for invoice scanning in accordance with an exemplary embodiment of the present invention;

FIG. 6 is a diagram of a method for invoice indexing in accordance with an exemplary embodiment of the present invention;

FIG. 7 is a diagram of a method for invoice formatting in accordance with an exemplary embodiment of the present invention;

FIG. 8 is a diagram of a method for paper invoice storage and processing in accordance with an exemplary embodiment of the present invention;

FIG. 9 is a diagram of a method for invoice submission in accordance with an exemplary embodiment of the present invention;

FIG. 10 is a diagram of a method for invoice approval generation in accordance with an exemplary embodiment of the present invention;

FIG. 11 is a diagram of a method for supplier invoice query and investigation in accordance with an exemplary embodiment of the present invention;

FIG. 12 is a diagram of a system for managing accounts payable invoices in accordance with an exemplary embodiment of the present invention; and

FIG. 13 is a diagram of a method for managing accounts payable invoices in accordance with an exemplary embodiment of the present invention.

### DETAILED DESCRIPTION OF THE PRESENT INVENTION

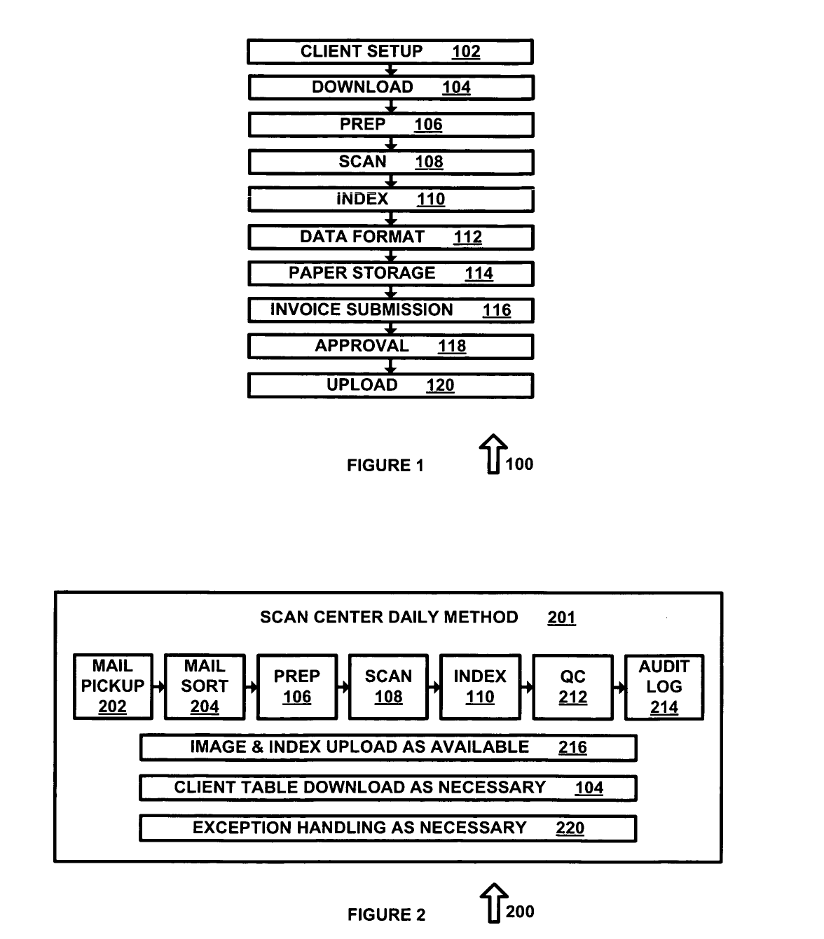

Referring to FIG. 1, there is shown at 100 a diagram of a method for invoice entry and approval in accordance with an exemplary embodiment of the present invention. Method 100 allows for an invoice to be managed from entry to approval.

Method 100 begins at 102 where the method is initiated through client setup. In one exemplary embodiment, a client profile is created that includes one or more data fields selected from a plurality of user-selectable data fields, such as a list of general ledger entry items. In one exemplary embodiment, if the client profile is for a builder, the general ledger entry items can include types of building materials (such as nails, drywall, doors, cement, or other physical items), types of services (such as carpenter labor, plumber labor, electrician labor, or other services), or other suitable general ledger items. Likewise, general ledger items for other types of businesses can be provided and selected by a user for creation of the client profile. The data fields can also be associated with vendor information, such as by selecting one or more of a plurality of vendors from a vendor master list. In a second exemplary embodiment, one or more vendors may be used to provide building materials, services, or other items, and the user profile can be created by selecting vendors from a list of vendors, adding new vendors to the list of vendors, or performing other suitable processes. An indexing template can be generated using the selected data fields, payment terms and conditions, business logic, approval process, and other requirements. In a second exemplary embodiment, a P.O. Box is established for clients to receive their invoices. The method then proceeds to 104.

At 104, the client profile, G/L codes, valid purchase orders, client employee information, and vendor master tables are retrieved and a plurality of rules can be applied. The plurality of client information can be updated in real-time via an Application Programming Interface (API) to modify the client-specific indexing template. The method then proceeds to 106.

At 106, the method prepares the invoices for indexing and digitization. In one exemplary embodiment, the invoices can be collected from a P.O. Box for processing. In a second exemplary embodiment, the invoices can be electronically submitted for processing. The method then proceeds to 108.

At 108, paper invoices are digitized to create a digital accounts payable invoice. The digital accounts payable invoice can be an image, a data file, or any other type of electronic format. In one exemplary embodiment, the invoices are scanned. In a second exemplary embodiment, the invoices are received via FAX. In a third exemplary embodiment, the invoices are received electronically in EDI or XML format. In a fourth exemplary embodiment, the invoices are received through e-mail. In a fifth exemplary embodiment, The method then proceeds to 110.

At 110, the invoices are indexed by distilling relevant information elected in the client profile. In one exemplary embodiment, the indexes are distilled through data entry keying from the digital accounts payable invoice. In a second embodiment, the indexes are distilled through the use of optical character recognition (OCR). Client indexing templates are referenced to determine which fields are required to be reported. The method then proceeds to 112.

At 112, the invoices and associated index information are formatted into a format for downstream processing by an approval workflow system. In one exemplary embodiment, acceptable third party approval workflow systems include: the Apptricity software family available from Apptricity Corporation of Irving, Tex., the FileNet software family available from FileNet, an IBM Company of Costa Mesa, Calif., and the Documentum software family available from EMC Corporation of Hopkinton, Mass. In a second exemplary embodiment, the data format is an XML file with corresponding images in TIFF or PDF format. The method then proceeds to 114.

At 114, the paper invoices are archived for possible physical reference. In one exemplary embodiment, the paper invoices are stored by a third party provider off site. The method then proceeds to 116.

At 116, the invoice is submitted to the workflow approval engine which manages the approval process. The method then proceeds to 118.

At 118, the invoice is approved or denied. In one exemplary embodiment, the approval process is governed by the business rules, invoice index information, and personnel approval guidelines detailed in the client profile. The method then proceeds to 120.

At 120, the approved invoice is uploaded. In one exemplary embodiment, the invoice is uploaded into an accounting system.

Referring now to FIG. 2, there is shown at 200 a method for scan center operation in accordance with an exemplary embodiment of the present invention. Method 200 details a daily scan center process for invoice management and processing. In one exemplary embodiment, a digital accounts payable invoice is created based on a hard copy accounts payable invoice and stored on a network storage device. Method 200 includes scan center daily method 201 which is further comprised of mail pickup 202, mail sort 204, prep 206, scan 208, index 210, quality check (QC) 212, Audit log 214, image & index upload 216, client table download 218, and exception escalation 220. Also or alternatively, method 200 can be performed at periods other than daily, such as on demand, after several days (such as after a weekend or holiday), or in other suitable manners.

Method 200 begins at 202 where the method is initiated with mail pick up at the P.O. Box. In one exemplary embodiment, the mail is picked up at a P.O. Box and brought to the scan center for processing. The method then proceeds to 204.

At 204, the mail is sorted. In one exemplary embodiment, mail not addressed to the client is separated and returned to the post office. In a second embodiment, correspondence to the client is separated and handled according to the rules set forth in the client profile. In a third embodiment, hard copy accounts payable invoices for the client are separated from the rest of the mail and processed. The method then proceeds to 106.

At 106, the hard copy accounts payable invoice is prepared for digitization. In one preferred embodiment, the invoices are gathered in a batch envelope for delivery to the scanning area. The method then proceeds to 108.

At 108, the digital accounts payable invoice is generated from the hard copy invoice. In one exemplary embodiment, a Tag Image File Format (TIFF) file is generated for each invoice. The method then proceeds to 110.

At 110, the invoice is indexed by distilling relevant information elected in the client profile. In one exemplary embodiment, the invoice does not have an associated index template and so a generic index template is utilized. The method then proceeds to 212.

At 212, a quality check is performed to ensure the integrity of the invoice data. The method then proceeds to 214.

At 214, the scan center actions are logged for auditing purposes.

Additionally, the method has three asynchronous processes including image and index upload 216, client table download 104, and exception escalation 220. These three processes are to occur as needed.

At 216, the digital accounts payable invoice and its associated electronic invoice data file are uploaded to a database. In one exemplary embodiment the invoice images and indexes are stored in the network storage device for further processing.

At 104, the client table, containing all of the reference data used in the method, is downloaded as necessary. The client profile is retrieved and a plurality of rules in the client profile are applied in order to process the digital accounts payable invoice and its associated electronic index file. In one exemplary embodiment, the client table includes a vendor master table, which includes all of the client's vendor specific information (i.e. name, address, phone, payment terms, and interface information). As vendors and their related data change aperiodically, this information is downloaded as necessary. An auto-interface occurs with the client's data tables through an Application Program Interface (API). In one exemplary embodiment, the client table is downloaded with an import/export functionality of the client's accounting package or PO system. In a second exemplary embodiment, a client table includes Human Resources (HR) information, user information, hierarchical reporting rules, and coding information. The vendor information from the client table is used to populate invoice index fields by the indexer at the front end in order to minimize errors and streamline the invoice routing process.

At 220, exception handling is utilized whenever anything other than an invoice is received at the P.O. Box. The item is handled according to the rules outlined in the exception handling process. In one exemplary embodiment, correspondence is received in the P.O. Box, scanned, and e-mailed to the stipulated address.

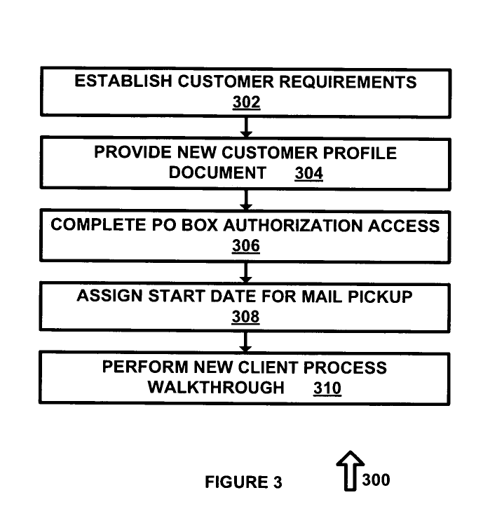

Referring to FIG. 3, there is shown at 300 a diagram of a method for client system setup in accordance with an exemplary embodiment of the present invention. Method 300 details a typical client setup procedure. The method details the deployment of the client's business rules to accommodate different circumstances within the client's process.

Method 300 begins at 302, where company representatives meet with clients to establish requirements. In one exemplary embodiment, a client stipulates who approves invoices, what their approval limit is, and what the exception conditions are. Advantageously, the client determines the critical information required from the invoice for retrieval and routing. In a second exemplary embodiment, the hard copy retention period is stipulated and information destruction rules. This client defined information is implemented in software through configuration and parameter changes. In a third exemplary embodiment, the client can elect to gather vendor specific information from the invoices. The method then proceeds to 304.

At 304, a new client profile is created. In one exemplary embodiment, a Client Profile Document will contain information including: client name, P.O. box number, PDF or TIFF format election, expected monthly volumes, expected invoice size, index fields to be manually keyed or extracted through OCR, single or double key indexing, OCR confidence threshold, invoice hard copy retention period, paper destruction profile, and image/data destruction profile. The method then proceeds to 306.

At 306, P.O. Box authorization access is stipulated. In one exemplary embodiment, the client authorizes access for workers at the scan center in order to collect the invoices for processing. The method then proceeds to 308.

At 308, a start date for mail pickup is determined. In one exemplary embodiment, the client intends to send notification of the P.O. Box address at the first of the month, and determines to start collection of mail two days after said notification. The method then proceeds to 310.

At 310, new client process walkthrough is performed to ensure that all processes are performing as indicated. In one exemplary embodiment, the walk through also involves training and procedure explanation.

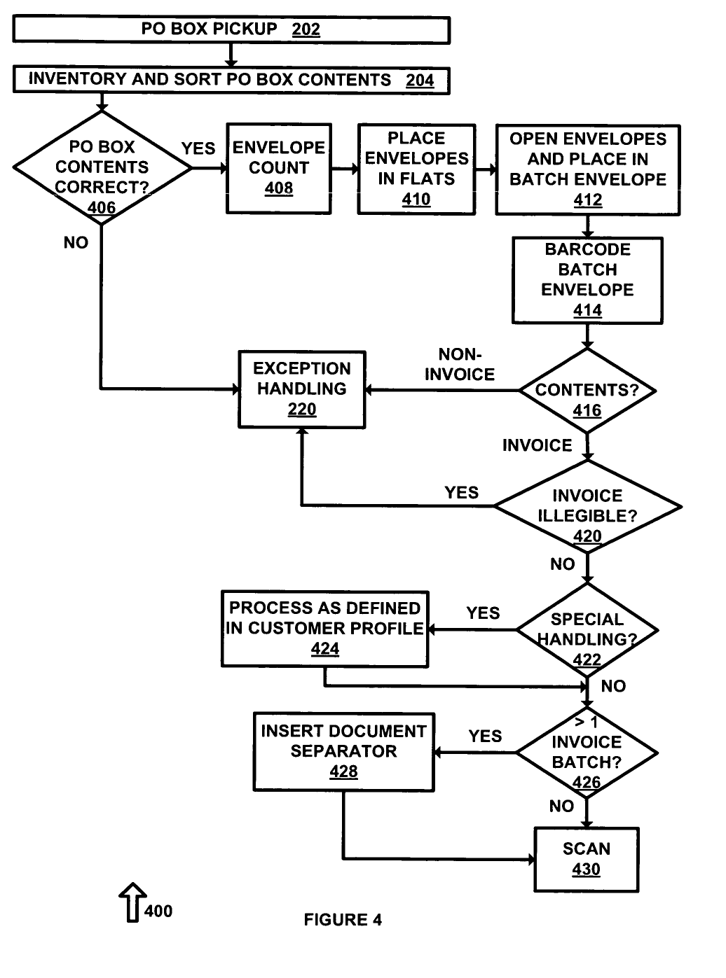

Referring to FIG. 4, there is shown at 400 a diagram of a method for mail sorting and processing in accordance with an exemplary embodiment of the present invention. Method 400 details a process for mail retrieval, sorting, processing, and routing.

Method 400 begins at 202, mail pickup at the P.O. Box. The method then proceeds to 204.

At 204, the P.O. Box contents are inventoried and sorted. In one exemplary embodiment, the mail is sorted into invoices, correspondence, and other. The method then proceeds to 406.

At 406, there is shown a P.O. Box contents decision block. If the P.O. Box contents are correct, the method proceeds to 408. If the P.O. Box contents are not correct, the method proceeds to 220.

At 220, exception handling is utilized when mail is not addressed to the appropriate location. In one exemplary embodiment, processing time starts upon scheduled pickup and the name of the driver performing pickup, the P.O. Box number, and the pickup time are logged. In a second exemplary embodiment, mail addressed to a different P.O. Box is separated and placed into a return to Post Office container to be returned to the Post Office on the next scheduled pickup date.

At 408, the envelopes received are counted for logging. The method then proceeds to 410.

At 410, the envelopes are placed in flats for processing. The method then proceeds to 412.

At 412, the envelopes are opened and the invoices placed in a batch envelope for manageability. The invoices are bundled by placing them into a large envelope. Once the invoices in the envelope reach a predefined quantity, the envelope is sealed and a new envelope is opened for invoice bundling. The method then proceeds to 414.

At 414, the batch envelopes are affixed with a barcode for tracking purposes. The method then proceeds to 416.

At 416, there is shown a contents decision block. The method proceeds to 220 if the contents of the batch envelope are not invoices. The method proceeds to 420 if the contents of the batch envelope are invoices.

At 220, exception handling is utilized when anything other than an invoice is received at the P.O. Box. In one exemplary embodiment, correspondence with the clients shipping department is separated and sent to the appropriate party.

At 420, there is shown an illegible invoice decision block. The method proceeds to 220 if the invoices are illegible. The method proceeds to 422 if the invoice is legible.

At 220, exception handling is utilized when an invoice is illegible. In one exemplary embodiment, a vendor is contacted when one of their submitted invoices is illegible and prompted for resubmission of said invoice.

At 422, there is shown a special handling decision block. The method proceeds to 424 if the invoice requires special handling. The method proceeds to 426 if the invoice does not require special handling.

At 424, an invoice requiring special handling is processed as defined in the client profile. In one exemplary embodiment, only the first 10 pages of invoices over ten pages are forwarded for processing. In a second exemplary embodiment, an accounts payable manager is phoned when an invoice is received from a particular vendor. The method then proceeds to 426.

At 426, there is shown a greater than one page decision block. The method proceeds to 428 if there is more than one invoice in the envelope batch. The method proceeds to 108 if there is a single invoice in the batch envelope.

At 428, a separator page is inserted between each invoice. The method then proceeds to 108.

At 108, the invoices are digitized.

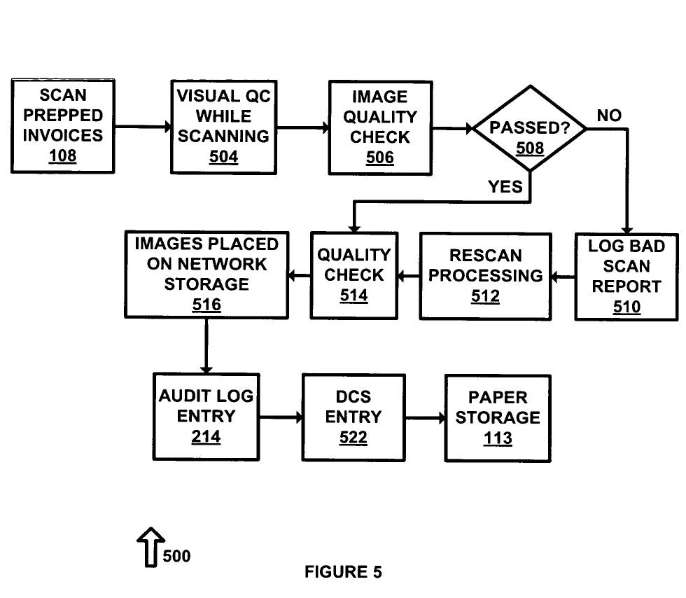

Referring to FIG. 5, there is shown at 500 a diagram of a method for invoice scanning in accordance with an exemplary embodiment of the present invention. Method 500 details a process for digitizing the processed hard copy invoices.

Method 500 begins at 108, where the previously processed invoices are physically digitized. In one exemplary embodiment, a scanner is used to digitize the invoices and generate a Group IV TIFF file. The method then proceeds to 504.

At 504, a visual quality check is performed. In one exemplary embodiment, a monitor is used to verify that there is no debris on the scanner lens causing distortion of the digitized invoices. In a second exemplary embodiment, a monitor is used to verify that image processing attributes, such as contrast and sharpness levels, of the digitized invoices are properly set. This quality check is a coarse check for gross distortion, as the invoices are scanned with high speed devices (currently 180 pages per minute). The method then proceeds to 506.

At 506, an image quality check is performed to verify the legibility and integrity of the digitized invoices. Every image is reviewed by Image Quality Control. In one exemplary embodiment, a person reviews every image to ensure that the digitized (digital) image can be read and that the image is not misaligned. The method then proceeds to 508.

At 508, there is shown a passed decision block. If the image quality check is passed, the method proceeds to 514. If the image quality check is failed, the method proceeds to 510.

At 510, a bad scan report is logged. In one exemplary embodiment, the time, date, scanner number, invoice batch number, and reviewer name is logged in the bad scan report. The method then proceeds to 512.

At 512, the invoices that require rescanning are processed for rescanning. In one exemplary embodiment, the invoices to be rescanned are routed back to the scanner operator and rescanned. The method then proceeds to 514.

At 514, a final quality check is performed to ensure that the digital image is a true reproduction of the hard copy original before the digital invoices are archived. In one exemplary embodiment, the digital invoice is reviewed to ensure that all pages are present and no extra pages are included. The method then proceeds to 516.

At 516, the invoice digital images are archived. In one exemplary embodiment, the digitized invoices are stored on a network storage device. The hard copy invoices proceed to 113, while the method proceeds to 214.

At 214, all relevant information is recorded in the audit log. In one exemplary embodiment, the number of images generated, the file names, and the file sizes are entered into the audit log. The method then proceeds to 522.

At 522, all relevant information is recorded in the Document Control Sheet (DCS). The DCS is the summary sheet that accompanies the invoice batch throughout the physical paper life of the invoices. In one exemplary embodiment, the DCS contains the number of hard copy invoices and the number of hard copy pages is entered. In a second exemplary embodiment, the name of the person scanning the invoices, sorting the invoices, and the timestamp are logged in the DCS. The method then proceeds to 113.

At 113, the hard copy invoices are stored in a storage facility. In one exemplary embodiment, the hardcopy invoices are sent to a third party storage facility for retention.

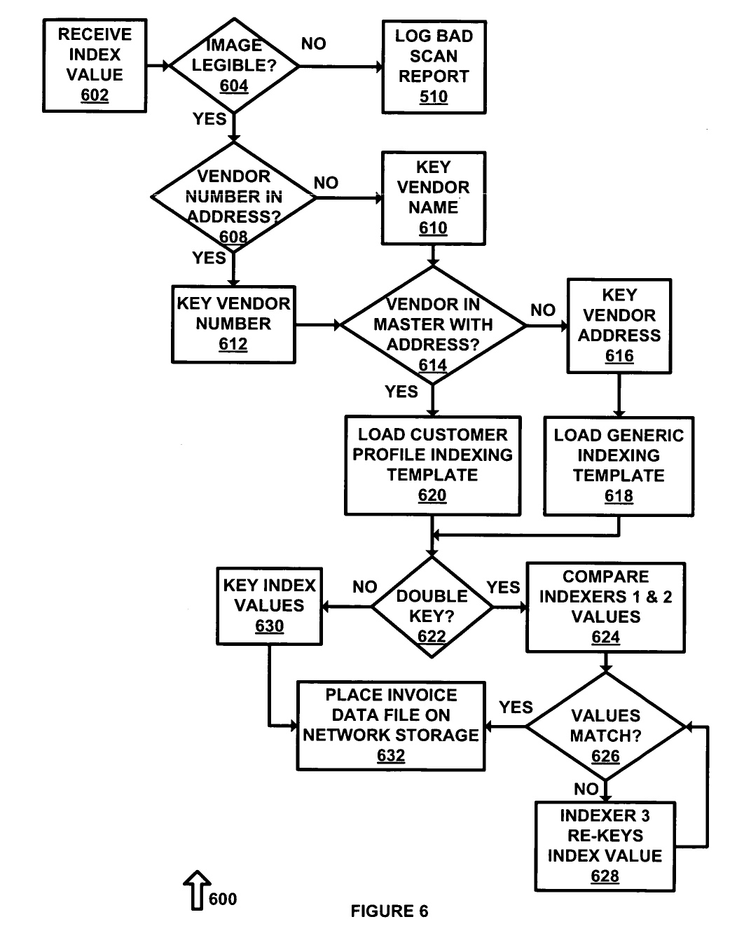

Referring to FIG. 6, there is shown at 600 a diagram of a method for invoice indexing in accordance with an exemplary embodiment of the present invention. Method 600 details a process for categorizing (indexing) specified fields of the digital accounts payable invoice. An indexing center generates and populates an electronic invoice data file with data from the digital accounts payable invoice. The invoice fields are manually input into the electronic invoice data file via an invoice data file interface. The invoice data file interface can be implemented in hardware, software or a suitable combination of hardware and software and which can be one or more software systems upgrading on a general purpose processing platform. Each client's unique profile provides instruction and template procedures for indexing invoices and the process may be unique for each vendor. This information is loaded into the indexing system as the images are received for the client.

Method 600 begins at 602, where a digital accounts payable invoice is received by the invoice data file interface. In one exemplary embodiment, the corresponding client profile and indexing rules are loaded with the digital accounts payable invoice for indexing. The method then proceeds to 604.

At 604, there is shown an image legible decision block. Due to the subjective nature of legibility, what is legible to one person may not be legible to another. In one exemplary embodiment, the indexer doing the indexing determines whether the digital invoice is legible. If the digital invoice is legible, the method proceeds to 608. If the digital invoice is not legible, the method proceeds to 510.

At 510, a bad scan report is logged.

At 608, there is shown a vendor number in address decision block. If the vendor number is in the invoice address, the method proceeds to 612. If the vendor number is not in the invoice address, the method proceeds to 610.

At 610, the indexer enters the vendor name into the invoice data file interface. The method then proceeds to 614.

At 612, the indexer enters the vendor number into the invoice data file interface. The method then proceeds to 614.

At 614, there is shown a vendor in master with address decision block. In one exemplary embodiment, the vendor number will be represented as “Vendor Number” in the address information. If the vendor is present in the vendor master list, and the invoice address is the same as the vendor master table address, the method proceeds to 620. If the vendor is not in the vendor master list, or there is not an associated address, the method proceeds to 616.

At 620, an indexing template, also known as an electronic data file template, is loaded from the client (customer) profile for determining requisite fields for input into the invoice data file interface. In one exemplary embodiment, the indexing template lists which fields from the invoice are required for a specific vendor. Such as item, quantity, vendor name, vendor address, and total amount. The method then proceeds to 622.

At 616, the vendor address is manual keyed into the invoice data file interface. The method then proceeds to 618.

At 618, a generic indexing template is utilized in determining requisite fields for input into the invoice data file interface. In one exemplary embodiment, the generic indexing template lists a set of default fields to index from the invoice. The method then proceeds to 622.

At 622, there is shown a double key decision block. A double keying process has two independent indexers who key in index information as they understand it from an invoice image. The data keyed by both indexers is then compared for quality control purposes. If two indexers are to be used, the method proceeds to 624. If one indexer is to be used, the method proceeds to 630.

At 630, a single indexer keys in the requisite invoice values into the invoice data file interface. The method then proceeds to 632.

At 624, two separate indexers key in the requisite invoice values into the invoice data file interface and those values are compared for accuracy. The method then proceeds to 626.

At 626, there is shown an invoice (index) values match decision block. If the index values from both indexers are the same, the method proceeds to 632. If the index values from both indexers are different, the method proceeds to 628.

At 628, a third indexer is enlisted to re-key the index value in question. The method then returns to 626.

At 632, the electronic invoice data file is saved on the network storage. In one exemplary embodiment, the electronic invoice data file contains vendor name, vendor number, vendor address, vendor phone, invoice received date, and total invoice amount.

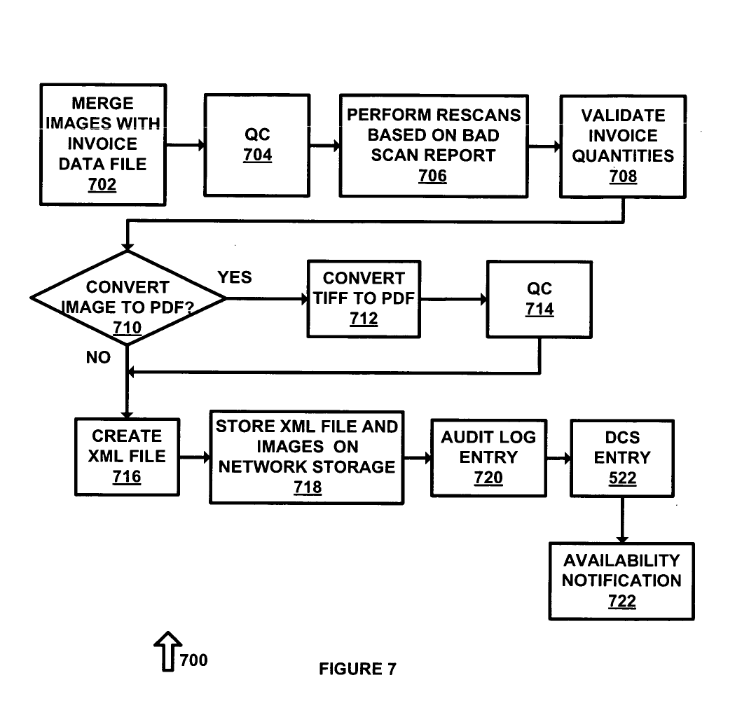

Referring to FIG. 7, there is shown at 700 a diagram of a method for invoice formatting in accordance with an exemplary embodiment of the present invention. Method 700 details a process for formatting invoice data for rendering on the internet. The digital invoice and the electronic invoice data file are combined for electronic submission.

Method 700 begins at 702, where invoice images are merged with their respective electronic invoice data file. In one exemplary embodiment, the electronic invoice data file is linked to its corresponding digital invoice image. The method then proceeds to 704.

At 704, a quality check is performed to ensure that an invoice's digital image and electronic invoice data file were correctly matched. In one exemplary embodiment, an operator compares the data from a linked digital invoice and electronic invoice data file pair. The method then proceeds to 706.

At 706, rescan information is merged for any images that required rework due to quality issues. The method then proceeds to 708.

At 708, a validation is performed to ensure that a digital invoice image—electronic invoice data file pair is generated for each invoice. The method then proceeds to 710.

At 710, there is shown a convert to PDF decision block. If the client profile stipulates that the digital invoice image should be converted into a PDF file, the method proceeds to 712. If the client profile does not stipulate that the digital invoice image should be converted into a PDF file, the method proceeds to 716.

At 712, the digital invoice TIFF file is converted into a PDF file. The method then proceeds to 714.

At 714, a quality check is conducted to ensure that the PDF file was successfully created with no distortion. The method then proceeds to 716.

At 716, an electronic approval file is created for rendering of the digital invoice and the electronic invoice data file data. In one exemplary embodiment, the electronic approval file is an Extensible Markup Language (XML) file generated according to parameters stipulated in the client profile. In a second exemplary embodiment, the data is extracted from the electronic invoice data file into an XML file along with the digital invoice for rendering on a web-enabled browser. The method then proceeds to 718.

At 718, the electronic approval file and related images are stored on network storage. The method then proceeds to 214.

At 214, actions taken are entered into the audit log. In one exemplary embodiment, the invoice number, the date, and the time are logged. The method then proceeds to 522.

At 522, actions taken are entered into the DCS. In one exemplary embodiment, the name of the operator converting the TIFF files to PDF files is logged. The method then proceeds to 722.

At 722, the invoice is uploaded into the approval workflow system. In one exemplary embodiment, the responsible party, as stipulated in the client profile and associated business rules, is notified via e-mail that a new invoice is available for approval.

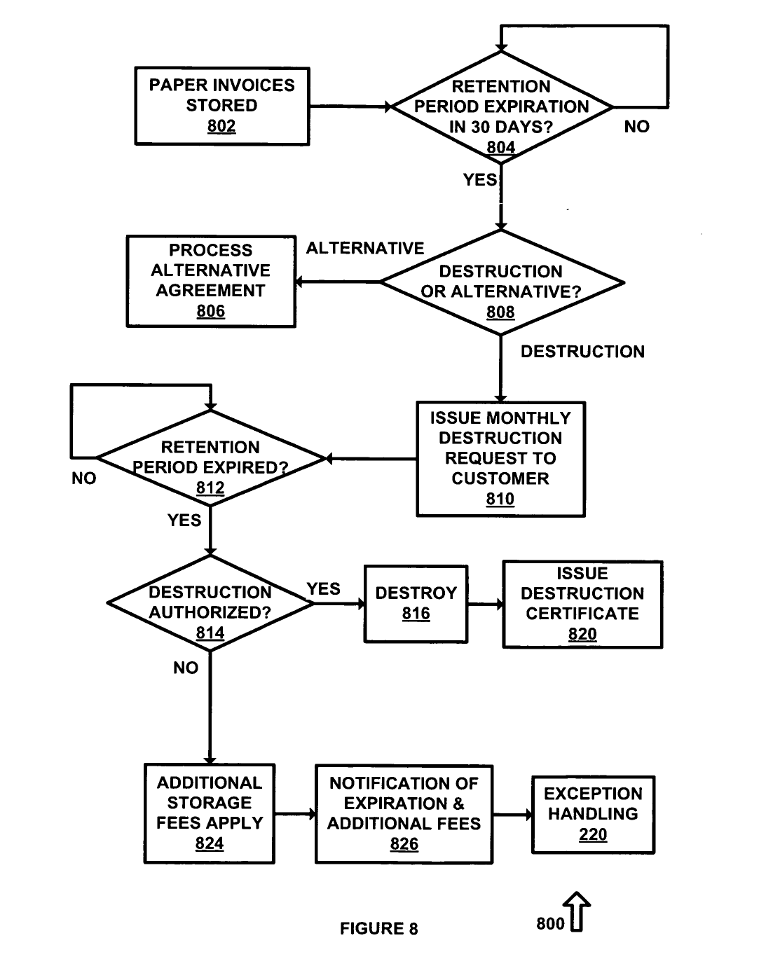

Referring to FIG. 8, there is shown at 800 a diagram of a method for paper invoice storage and processing in accordance with an exemplary embodiment of the present invention. Method 800 details a process for hard copy invoice retention and destruction.

Method 800 begins at 802, where the invoices are sent to a storage location for retention. The method then proceeds to 804.

At 804, there is shown a retention period expiration in 30 days decision block. If the retention period expires in 30 days, the method proceeds to 808. If the retention period does not expire in 30 days, the method returns to 804.

At 808, there is shown a destruction or alternative decision block. If, in 30 days, the hard copy invoice is to be destroyed, the method proceeds to 810. If, in 3u days, the hard copy invoice is to be handled in accordance with an alternative to destruction, the method proceeds to 806.

At 806, the invoice is processed as stipulated in an alternative agreement. In one exemplary embodiment, a client stipulates that after 30 days, the invoice should be sent to a warehouse for long term storage.

At 810, a monthly destruction request is issued to the client. In one exemplary embodiment, for clients with a 60 day retention period, on June 1, a request is issued stating “Please authorize the destruction of invoices for all invoices received between May 1 and May 30 for destruction on June 30.” The method then proceeds to 812.

At 812, there is shown a retention period expired decision block. If the retention period has expired, the method proceeds to 814. If the retention period has not expired, the method returns to 812.

At 814, there is shown a destruction authorized decision block. If the hard copy invoice destruction is authorized, the method proceeds to 816. If the hard copy invoice destruction is not authorized, the method proceeds to 824.

At 816, the hard copy invoice is destroyed. The method then proceeds to 820.

At 820, a destruction certificate is issued to the client for auditing purposes.

At 824, the client is subject to additional storage fees for hard copy invoice retention. The method then proceeds to 826.

At 826, the client is notified of retention period expiration and any additional fees applicable to said retention. The method then proceeds to 220.

At 220, exception handling is conducted in accordance with the client profile. In one exemplary embodiment, a client has negotiated into a contract that retention fees will not be assessed until one month after the retention period has expired.

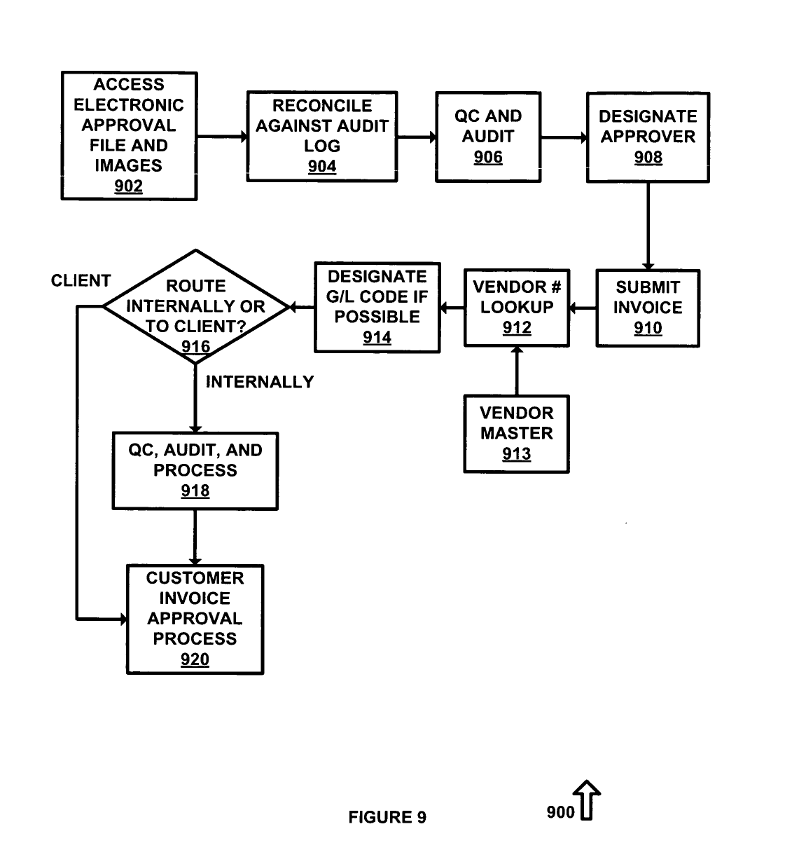

Referring to FIG. 9, there is shown at 900 a diagram of a method for invoice submission in accordance with an exemplary embodiment of the present invention. Method 900 details a process for routing invoices to the appropriate party for authorization. The digital accounts payable invoice is electronically routed to an authorized approver associated with an accounts payable invoice category for review.

Method 900 begins at 902, where an invoice's electronic approval file and digital image are accessed. In one exemplary embodiment, an authorized operator accesses the invoice by logging onto an invoice web portal with a username and password listed in the client profile via a web-enabled browser. The method then proceeds to 904.

At 904, the invoice data is reconciled against the audit log. The method then proceeds to 906.

At 906, a quality check is performed on the invoice data and audited for compliance with business logic stipulated in the client profile. The method then proceeds to 908.

At 908, an approver is designated for a specific invoice approval, as stipulated by the client profile or associated business rules. The method then proceeds to 910.

At 910, the invoice is submitted for processing. The method then proceeds to 912.

At 913, the vendor master table and G/L code tables are imported to allow for accurate G/L coding. In one exemplary embodiment, the vendor master table is downloaded with an import/export functionality of the client's accounting package. The method then proceeds to 912.

At 912, a vendor number lookup is performed to load the corresponding G/L code categories. The method then proceeds to 914.

At 914, the G/L codes associated with the invoice items in the electronic index file are coded if possible. The data in the electronic index file is assigned to predetermined categories, which are stipulated in the client profile. In one exemplary embodiment, the G/L code information, which classify goods and cost centers, that was downloaded in the client table is used to categorize the items in the invoice. Advantageously, business rules can be used to route invoices to the appropriate approver based on G/L codes. In a second exemplary embodiment, invoices for supplies can be approved by ten people, but building materials can only be approved by one specific person, so the invoice is routed accordingly. The method then proceeds to 916.

At 916, there is shown a route internally or to client decision block. If the invoice is to be routed internally, the method proceeds to 918. If the method is routed to the client, the method proceeds to 920.

At 918, internal quality check, audit, and special processing are performed on the invoice to provide an additional level of service for a client as stipulated in the client profile. In one exemplary embodiment, a client requests additional audit aspects and special processing be applied to an invoice. The method then proceeds to 920.

At 920, the client invoice approval process defined in the client profile will be initiated. In one exemplary embodiment, an invoice is paired with a purchase order for review for approval.

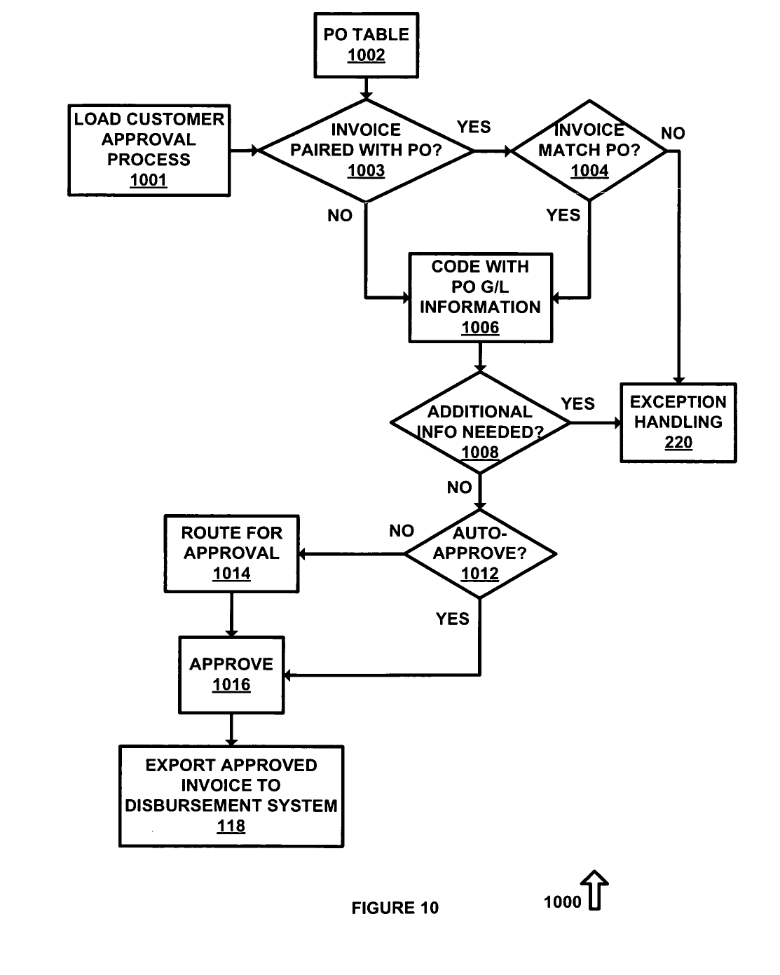

Referring to FIG. 10, there is shown at 1000 a diagram of a method for invoice approval generation in accordance with an exemplary embodiment of the present invention. Method 1000 details a process for providing the information required for review of an invoice for approval. The digital accounts payable invoice is electronically approved for disbursement. An approved digital accounts payable invoice is routed to a client's Enterprise Resource Planning (ERP) system for disbursement through an Application Programming Interface (API).

Method 1000 begins at 1001, where the customer approval process and business rule logic is loaded into an invoice review interface for processing. The method then proceeds to 1003.

At 1002, the Purchase Order (PO) table is imported for invoice pairing if not already paired. In one exemplary embodiment, the PO table is downloaded with an import/export functionality of the client's PO system. The method then proceeds to 1003.

At 1003, there is shown an invoice paired with PO decision block. If the invoice is already paired with a PO, the method proceeds to 1004. If the invoice is not already paired with a PO, the method proceeds to 1006.

At 1004, there is shown an invoice match PO decision block. If the invoice matches the PO, the method proceeds to 1006. If the invoice does not match the PO, the method proceeds to 220.

At 220, exception handling is utilized when an invoice does not match a PO. In one exemplary embodiment, an operator reviews both the invoice and the PO and determines the appropriate action.

At 1006, the invoice is coded with PO G/L information from the PO table. The method then proceeds to 1008.

At 1008, there is shown an additional information needed decision block. If any additional information is needed, the method proceeds to 220. If any additional information is not needed, the method proceeds to 1012.

At 220, exception handling is utilized when additional invoice information is needed. In one exemplary embodiment, an invoice is routed to an operator for review and correction.

At 1012, there is shown an auto-approve decision block. An auto approval can be generated if an invoice meets certain metrics detailed in the client profile and business rules. In one exemplary embodiment, an invoice for a specific vendor is below a certain dollar amount stipulated in the client profile, has all requisite information for approval, and is not a duplicate. The invoice does not require an approver to review it, and is therefore auto approved. If the invoice is auto-approved, the method proceeds to 1016. If the invoice is not auto-approved, the method proceeds to 1014.

At 1014, the invoice is routed to an authorized approver for approval. The business rules define who the approver is based on the index information. In one exemplary embodiment, an e-mail is sent to an approver stating that an invoice is available for review. In a second embodiment, an e-mail is not used and the “ready for approval” queue that exists in the workflow and routing system is updated for the specific user. The approver is then presented with an image of the invoice and all corresponding index information. Also associated with the decision are notes that have been electronically attached from previous approvers throughout the approval process. The method then proceeds to 1016.

At 1016, an invoice is designated approved if determined by the approver or all of the requirements for auto-approval have been met. The method then proceeds to 118. Invoices that are not approved are then denied and re-routed through business rules to other personnel responsible for correcting the invoice or returning it to the vendor.

At 118, an approved invoice is exported to a disbursement system. In one exemplary embodiment, invoice review interface has an import/export function for invoice transmission to an Enterprise Resource Planning (ERP) system for disbursement via an API.

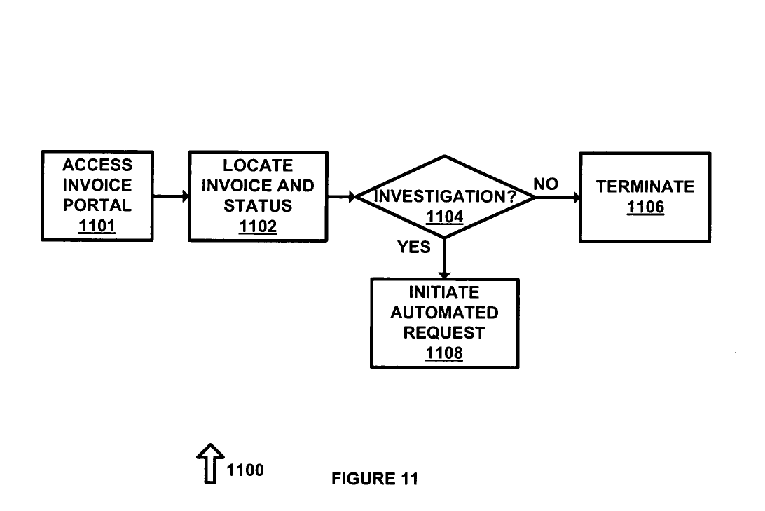

Referring to FIG. 11, there is shown at 1100 a diagram of a method for supplier invoice query and investigation in accordance with an exemplary embodiment of the present invention. Method 1100 details a process for allowing a vendor to check the status of their invoice.

Method 1100 begins at 110 1, where an invoice portal is accessed. In one exemplary embodiment, a vendor utilizes an office computer connected to the internet to access the invoice portal. The method then proceeds to 1102.

At 1102, an invoice is located and its status is displayed to the vendor. In one exemplary embodiment the vendor logs on to the invoice portal to receive information regarding an invoice status, such as: received, in processing, or a check has been issued. In a second exemplary embodiment, a message system notifies the vendor of certain error-handling events, such as: missing parts, illegible invoices, or notification of an invoice partial pay. The method then proceeds to 1104.

At 1104, there is shown an investigation decision block. A vendor can choose to investigate the status of an invoice, if they choose. In one exemplary embodiment, an invoice has a status of “in process,” which the vendor can investigate if they feel it has been delayed. If an invoice is to be investigated, the method proceeds to 1108. If an invoice is not to be investigated, the method proceeds to 1106.

At 1106, the vendor terminates the invoice portal session by logging out.

At 1108, an automated investigation request is initiated. In one exemplary embodiment, a vendor clicks on an investigate button, which notifies an invoice operator of the invoice investigation request for a specific invoice.

Once the digital accounts payable invoices are processed (approved or denied), they can be easily retrieved from any web-enabled browser. For instance, they can be retrieved through an end-user query based on any of the index information (e.g. vendor name, amount, due date, G/L code, etc.). This eliminates unnecessary manual labor associated with paper-based processing where a physical document must be retrieved from a paper archive room.

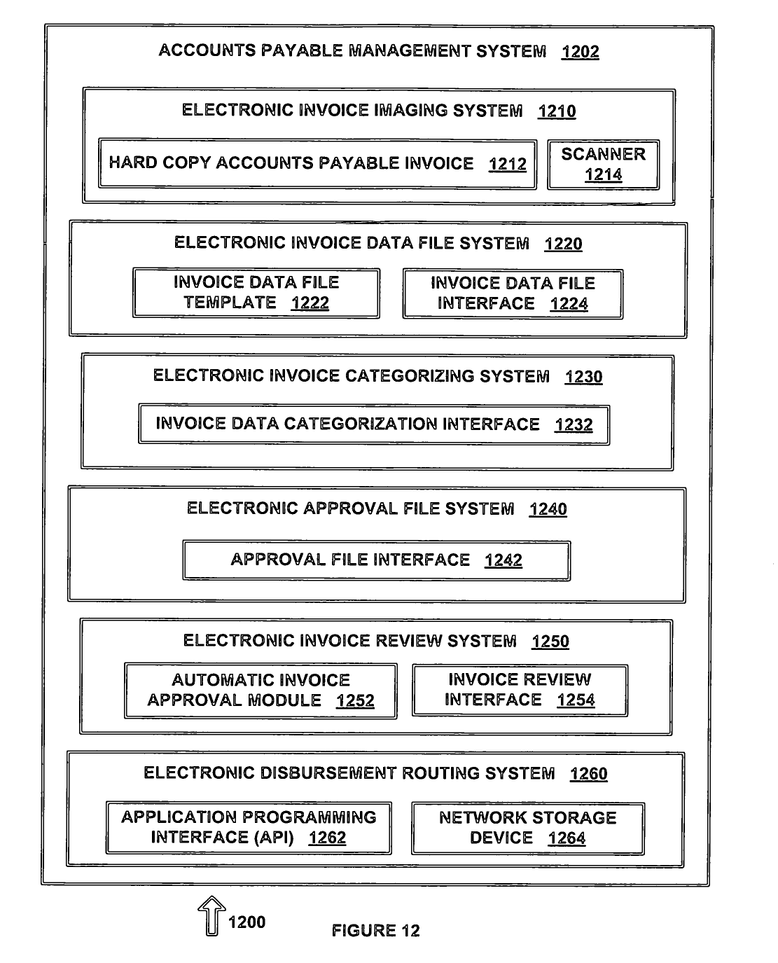

Referring to FIG. 12, there is shown at 1200 a diagram of a system for managing accounts payable invoices in accordance with an exemplary embodiment of the present invention. System 1200 details the elements used in managing accounts payable invoices.

System 1200 includes accounts payable management system 1202, which is further comprised of electronic invoice imaging system 1210, electronic invoice data file system 1220, electronic invoice categorizing system 1230, electronic approval file system 1240, electronic invoice review system 1250, and electronic disbursement routing system 1260, which can be implemented in hardware, software or a suitable combination of hardware and software and which can be one or more software systems upgrading on a general purpose processing platform.

In an exemplary embodiment, electronic invoice imaging system 1210, digitizes the hard copy accounts payable invoices 1212 by using a scanner 1214 to generate a digital accounts payable invoice image.

The electronic invoice data file system 1220 generates the invoice data file from the digital accounts payable invoice image generated by the electronic invoice imaging system 1210. An invoice data file template 1222 is correlated to the electronic invoice data file interface 1224 to select the fields in the digital accounts payable invoice that will be used to generate an electronic invoice data file with data from the digital accounts payable invoice.

The electronic invoice categorizing system 1230 assigns the data in the electronic invoice data file to predetermined categories in one of a plurality of client profiles using the invoice data categorization interface 1232.

The electronic approval file system 1240 generates an electronic approval file for electronic submission through the approval file interface 1242 by combining the digital accounts payable invoice image and the electronic invoice data file.

The electronic invoice review system 1250 allows an authorized approver to review the electronic invoice data file and approve, partially approve, hold, or deny disbursement for the electronic approval file through an invoice review interface 1254 and export disbursement approval data for disbursement. Advantageously, an automatic invoice approval module 1252 can approve invoice disbursement if the electronic invoice data file meets criteria listed in the client profile.

The electronic disbursement routing system 1260 routes approved invoices to a client's disbursement system through an Application Programming Interface (API) 1262 adapted to export disbursement approval data. A network storage device 1264 is adapted to store the disbursement approval data for import into an Enterprise Resource Planning (ERP) system. In one exemplary embodiment, the network storage device is a relational database.

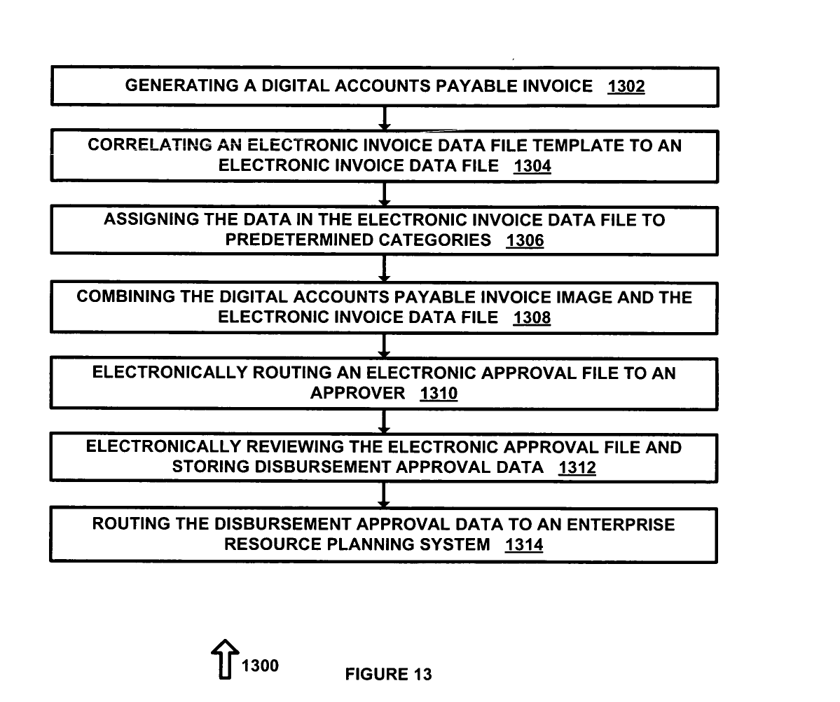

Referring to FIG. 13, there is shown at 1300 a diagram of a method for managing accounts payable invoices in accordance with an exemplary embodiment of the present invention. Method 1300 details a process for managing accounts payable invoices, which can be implemented in hardware, software or a suitable combination of hardware and software and which can be one or more software systems upgrading on a general purpose processing platform.

Method 1300 begins at 1302, by generating a digital accounts payable invoice image based on a hard copy accounts payable invoice and storing on a network storage device. The method then proceeds to 1304.

At 1304, correlating an electronic invoice data file template to an electronic invoice data file interface to select the fields in the digital accounts payable invoice that will be used to generate an electronic invoice data file with data from the digital accounts payable invoice. The method then proceeds to 1306.

At 1306, assigning the data in the electronic invoice data file to predetermined categories in one of a plurality of client profiles using the electronic invoice data file interface. The method then proceeds to 1308.

At 1308, combining the digital accounts payable invoice image and the electronic invoice data file into an electronic approval file for electronic submission. The method then proceeds to 1310.

At 1310, electronically routing the electronic approval file to an authorized approver associated with the digital accounts payable invoice category for review. The method then proceeds to 1312.

At 1312, electronically reviewing the electronic approval file and exporting disbursement approval data for disbursement. The method then proceeds to 1314.

At 1314, routing the disbursement approval data to an Enterprise Resource Planning (ERP) system after the exporting step.

As used herein, a hardware system can include discrete semiconductor devices, an application-specific integrated circuit, a field programmable gate array, a general purpose processing platform, or other suitable devices. A software system can include can include one or more objects, agents, lines of code, threads, subroutines, databases, application programming interfaces (APIs), web browser plug-ins, or other suitable data structures, and can include two or more different lines of code or suitable data structures operating in two or more separate software applications, on two or more different processing platforms, or in other suitable architectures. In one exemplary embodiment, a software system can include one or more lines of code or other suitable data structures operating in a general purpose software application, such as an operating system, and one or more lines of code or other suitable software structures operating in a specific purpose software application. In another exemplary embodiment, a software system can be implemented as a distributed software system, on a different processing platform than that shown in the exemplary embodiments herein, or in other suitable manners.

In one exemplary embodiment, the present invention derives technical advantages by providing a complete, end-to-end solution for accounts payable management for a plurality of clients. When the solution is provided using a network such as the Internet, there is no software to be purchased or maintained by a client. This greatly decreases the initial cost and increases the return on investment.

Second, the invoices and POs are matched at the front end. This allows categorized information to be propagated through each step of the process, saving valuable time and recourses. Third, there is reconciliation between received invoices and invoice indexes. This ensures that all invoices are accounted for and lowers the invoice error rate.

In another exemplary embodiment, the present invention achieves technical advantages by providing a complete audit trail of transactions including automated routing, approval, and payment for each of a plurality of clients based on client-specific requirements, such as to comply with funding source and other regulatory guidelines such as Sarbanes-Oxley.

The present invention achieves further technical advantages by providing the managed invoice management system under an application service provider (ASP) or software as a service (SaaS) delivery model. This delivery model does not require companies to purchase software or to install and manage the necessary infrastructure to operate the system. Instead, the system is primarily provided to a company under a transaction-based (i.e. price per invoice processed) pricing structure. By eliminating the large traditional upfront costs of implementing an automated invoice management system, companies with annual invoicing volume below 500,000 are able to take advantage of a viable system to reduce the costs of invoice processing and gain a greater control over expenses.

An important component of the system is its reporting capabilities which are used to create real-time alerts or historical review of invoice information and processing analytics. The system provides 25 standard reports, but because all of the invoice and audit information is held within the relational database 1264, customized reports are also available to the client. In one exemplary embodiment, one standard report logged is a cost center spending report. In a second exemplary embodiment, one standard report logged is an invoice aging report. In a third exemplary embodiment, one internal report logged is the bad scan report 510, which is stored in the relational database 51 0.

Though the invention has been described with respect to various exemplary embodiments, many variations and modifications will become apparent to those skilled in the art upon reading the present application. It is therefore the intention that the appended claims be interpreted as broadly as possible in view of the prior art to include all such variations and modifications.

What is claimed is:

1. A method for managing accounts payable invoices, comprising:
receiving a digital accounts payable invoice;
correlating an electronic invoice data file template to an electronic invoice data file interface to obtain client-selected fields having data in the digital accounts payable invoice and generate an electronic invoice data file with the associated data of the selected fields;
assigning the data in the electronic invoice data file to one or more of a plurality of categories in one of a plurality of client profiles using the electronic invoice data file interface;
combining the digital accounts payable invoice and the electronic invoice data file into an electronic approval file adapted for electronic submission;
electronically routing the electronic approval file based on client-specific business rules to one or more predetermined reviewers associated with the digital accounts payable invoice category for review;
receiving approval data for the electronic approval file and exporting disbursement approval data for disbursement; and
routing the disbursement approval data to an Enterprise Resource Planning (ERP) system.

2. The method of claim 1, further comprising the step of digitizing a paper invoice to create the digital accounts payable invoice.

3. The method of claim 1, further comprising the step of converting the digital accounts payable invoice into a format and storing the converted invoice on a network storage device.

4. The method of claim 1, further comprising the step of providing vendors the ability to input and review an approval process of the accounts payable invoice.

5. The method of claim 1, further comprising the step of providing comprehensive audit information pertaining to the process from when the digital accounts payable invoice was received until the digital accounts payable invoice was passed to the ERP system.

6. The method of claim 1, further comprising retrieving one of the client profiles and applying a plurality of rules in the client profile to process the digital accounts payable invoice and its associated electronic invoice data file.

7. The method of claim 2, wherein the plurality of client profile rules are updated in real-time via an Application Programming Interface (API) to the ERP system.

8. The method of claim 2, wherein the plurality of client profile rules are updated in real-time via an Application Programming Interface (API) to a Purchase Order system.

9. The method of claim 2, wherein the plurality of client profile rules are updated in real-time via an Application Programming Interface (API) to a Human Resources system.

10. The method of claim 1, further comprising:
selecting one of a plurality of vendors for the invoice data file template; and
associating one or more of the digital accounts payable invoice fields with the selected vendor.

11. The method of claim 1, wherein the electronic approval file is an Extensible Markup Language (XML) file generated according to parameters in the client profile.

12. The method of claim 1, wherein the method is performed using a web-enabled interface.

13. The method of claim 12, wherein the data is generated, processed, and routed electronically, via the Internet.

14. The method of claim 1, wherein routing the approved digital accounts payable invoice to the Enterprise Resource Planning (ERP) system is performed using an Application Programming Interface (API).

15. The API of claim 14, wherein coding information parameters are obtained from a general ledger (G/L) system.

16. The API of claim 14, wherein cost center allocation parameters are obtained from a general ledger (G/L) system.

17. The API of claim 14, wherein indexing parameters are obtained from the client profile.

18. The method of claim 1, wherein the invoice is retrieved via a web-enabled browser by querying based on one or more of the digital accounts payable invoice fields.

19. A system for managing accounts payable invoices, comprising:
an input adapted to receive a digital accounts payable invoice;
an electronic invoice data file system adapted to generate an electronic invoice data file from the digital accounts payable invoice, comprising an invoice data file template having a plurality of selectable invoice fields associated with the data fields of the digital accounts payable invoice;
an electronic invoice categorizing system adapted to associate the invoice fields in the invoice data file to one or more of a plurality of predetermined categories contained in one of a plurality of client profiles;
an electronic approval file system adapted to generate an electronic approval file including the digital accounts payable invoice and the electronic invoice data file;
an invoice review interface adapted to notify one or more of a plurality of predetermined authorized approvers based on one or more of the categories associated with the invoice data fields to review and approve the electronic invoice data file and to generate approval data; and
an electronic disbursement routing system adapted to route the approval data, comprising:
an Application Programming Interface (API) adapted to export the approval data; and
a network storage device adapted to store the disbursement approval data and adapted to import to an Enterprise Resource Planning (ERP) system.

20. The system of claim 19, wherein the input is adapted to receive a paper invoice to create the digital accounts payable invoice.

21. The system of claim 19, wherein the digital accounts payable invoice is stored on the network storage device.

22. The system of claim 19, wherein the electronic invoice data file is stored on the network storage device.

23. The system of claim 19, wherein the electronic approval file is stored on the network storage device.

24. The system of claim 19, further comprising an approval system managed through client-specific business rules and a workflow engine storing a plurality of approvers in a plurality of client profiles and adapted to allow an approver to be associated with one or more of the categories based on the client profile.

25. The system of claim 19, further comprising an invoice data file interface adapted to receive user-entered data associated with each of the selected invoice fields and adapted to generate the electronic invoice data file.

26. A system for managing accounts payable invoices, comprising:
electronic invoice data file means for generating an electronic invoice data file from a digital accounts payable invoice; and
electronic invoice categorizing means for associating data fields in the invoice data file to one or more of a plurality of predetermined categories contained in one of a plurality of client profiles.

27. The system of claim 26 further comprising electronic approval file means for generating an electronic approval file including the digital accounts payable invoice and the electronic invoice data file.

28. The system of claim 27 further comprising a relational database having an interface adapted to generate customizable reports as a function of electronic approval file means.

29. The system of claim 26 further comprising invoice review interface means for notifying one or more of a plurality of predetermined authorized approvers based on one or more of the categories associated with the invoice data fields to review the electronic invoice data file and to receive approval data.

30. The system of claim 26 further comprising electronic disbursement routing means for routing the electronic approval file approved in the electronic invoice review system to a disbursement system in response to the approval data.

31. The system of claim 26 further comprising approver selection means for storing a plurality of approvers in a plurality of client profiles and associating an approver with one or more of the categories.

32. The system of claim 26 further comprising electronic invoice imaging means for digitizing hard copy accounts payable invoices to create the digital accounts payable invoice.
